(19) United States
(12) Patent Application Publication
(10) Pub. No.: US 2002/0055970 A1
(43) Pub. Date: May 9, 2002

(54) Audio system, control apparatus, and title information registration method

(76) Inventor: Hirotaka Noro, Sagamihara-shi (JP)

Correspondence Address: NIXON PEABODY, LLP, 8180 GREENSBORO DRIVE, SUITE 800, MCLEAN, VA, 22102, US

(21) Appl. No.: 09/978,551

(22) Filed: Oct. 18, 2001

(30) Foreign Application Priority Data
Oct. 24, 2000 (JP) 2000-324364

(51) Int. Cl. G06F 15/16; G06F 13/12

(52) U.S. Cl. 709/203; 369/30.01; 710/72

(57) ABSTRACT

An audio system is provide which can easily register title information in a medium capable of recording music data and the like. A recording/reproducing apparatus transmits TOC information for identifying a CD to be reproduced, to a personal computer. Upon reception of this TOC information, the personal computer communicates with a management site for managing disk information of CD's via a network, and receives subject disk information from the management site by using the TOC information. Thereafter, the recording/reproducing apparatus started the record operation transmits record completion information to the personal computer when a record of music data is completed. Upon reception of this record completion information, the personal computer transmits title information (such as a track title) corresponding to the record completion information to the recording/reproducing apparatus. The recording/reproducing apparatus registers the received title information in an MD recorded with the music data.

### BACKGROUND OF THE INVENTION

1. Field of the Invention

The present invention relates to an audio system, a control apparatus, and a title information registration method, capable of facilitating to register title information in a recording medium capable of recording music data and the like.

2. Description of the Related Art

A recording/reproducing apparatus is known which can record music data (tone signals) obtained by reproducing a CD (Compact Disk) or the like, in an MD (Mini Disk) or the like.

Such a recording/reproducing apparatus has, for example, both a CD reproducing mechanism and an MD recording mechanism which are controlled by a control microcomputer. The recording/reproducing apparatus can record music data of CD reproduced by the CD reproducing mechanism in an MD by using the MD recording mechanism, with almost no deterioration of the sound quality and the like.

An MD has a U-TOC (User's Table of Contents) for recording title information including a disk title, a track title for each music data set, and the like.

After music data is recorded in an MD, the recording/reproducing apparatus acquires a disk title, track tiles and the like (title information) entered by a user, by using a predetermined operation unit, and registers the acquired title information in U-TOC of MD.

A CD text specification has been decided as a new CD specification. CD text disks in conformity with the CD text specification are prevailing. This CD text disk is recorded beforehand not only with a disk title and track titles but also with text data including an artist name, a songwriter, a composer, a message and the like of each piece of music.

Such a CD text disc can be reproduced by a recording/reproducing apparatus or the like in conformity with the CD text specification. When a CD text disk is loaded, the recording/reproducing apparatus reads the recorded text data and displays the disk title and the like on a predetermined display unit.

When music data reproduced from the CD text disk is recorded in an MD, the recording/reproducing apparatus can derive a disk title, track titles and the like (title information) from the read text data, and can register the derived title information in U-TOC of MD.

An operation of registering title information to be executed by such a recording/reproducing apparatus will be described with reference to FIG. 7. FIG. 7 is a flow chart illustrating a title information registration process to be executed by a control microcomputer or the like of the recording/reproducing apparatus. This title information registration process starts, for example, when music data is completely recorded from CD to MD.

First, a control microcomputer judges whether a CD to be reproduced is a CD text disk (Step S101). If it is judged that the CD is a CD text disk, text data is read from the CD text disk (Step S102).

The control microcomputer judges whether the read text data contains information of claiming a copyright (Step S103).

If the control microcomputer judges that the read text data does not contain information of claiming a copyright, it derives the disk title, track titles and the like from the text data and transfers the title information to a write memory for temporarily storing the title information (Step S104).

If it is judged at Step S101 that the CD is not a CD text disk or if it is judged at Step 103 that the read text data contains information of claiming a copyright, the control microcomputer initializes the write memory (Step S105).

After the memory is initialized, the control microcomputer displays a message urging a user to input title information, on a predetermined display unit, and stands by until the user enters a key input from a predetermined operation unit (Step S106).

When it is judged that a key input is entered, the control microcomputer judges whether the input key is a write key instructing a write operation of the title information in MD (Step S107).

If the control microcomputer judges that the input key is not a write key, it acquires character information of one character corresponding to the key input, and sets the acquired character information to the write memory as title information (Step S108).

After the title information is set to the memory, the flow returns to Step S106 and the control microcomputer repeats Steps S106 to S108.

If it is judged at Step S107 that the write key is input, the flow advances to Step S109.

At Step S109, the control microcomputer registers the title information stored in the write memory in MD. Namely, the control microcomputer registers title information set by the text data or set by the key input, in U-TOC of MD.

With this title information registration process, when music data is recorded from the CD text disk (without copyright in text data) to MD, the title information can be registered automatically in MD.

However, the conventional recording/reproducing apparatus can register the title information automatically only when a CD text disk not containing the information of claiming a copyright in text data is reproduced and recorded.

Therefore, when music data is recorded from a usual music CD to MD and the title information is registered, a user is required to enter all characters one character after another by operating upon a predetermined operation unit (operation key, remote controller or the like) of the recording/reproducing apparatus.

Registration of the title information by using the operation unit is generally complicated and its operability is not satisfactory. A user feels uncomfortable.

Even if the title information can be registered automatically from a CD text disk, a user may want to change the title information. For example, this case may be addition of a sub title to a disk title.

In such a case, the user is required to operate upon the operation unit of the recording/reproducing apparatus to change the title information. A user still feels uncomfortable.

### SUMMARY OF THE INVENTION

This invention has been made under such circumstances. It is an object of the invention to provide an audio system, a control apparatus, and a title information registration method, capable of facilitating to register title information in a recording medium capable of recording music data and the like.

In order to achieve the above object, according to a first aspect of the invention, there is provided an audio system having a recording/reproducing apparatus for reproducing/recording music data and a control apparatus for controlling the recording/reproducing apparatus, respectively connected via a predetermined interface, wherein:

the recording/reproducing apparatus comprises:

identification information transmitting means for transmitting identification information for identifying a reproduction medium recorded with music data, to the control apparatus;

completion information transmitting means for transmitting record completion information representative of a record completion, to the control apparatus, when a record of the music data is completed;

title information receiving means for receiving title information corresponding to the record completion information transmitted from the completion information transmitting means, from the control apparatus; and

registering means for registering the title information received by the title information receiving means in a record medium recorded with the music data, and wherein:

the control apparatus comprises:

identification information receiving means for receiving the identification information transmitted from the recording/reproducing apparatus by the identification information transmitting means;

communication means for communicating with a desired management server for managing disk information of reproduction media via a network and for receiving subject disk information from the management server by using the identification information received by the identification information receiving means;

completion information receiving means for receiving the record completion information transmitted from the recording/reproducing means by the completion information transmitting means; and

title information transmitting means for transmitted the title information corresponding to the record completion information among the disk information received by the communication means, to the recording/reproducing apparatus, when the completion information receiving means receives the record completion information.

According to the invention, the identification information transmitting means of the recording/reproducing apparatus transmits identification information (e.g., TOC information) for identifying a reproduction medium (e.g., CD) recorded with music data, to the control apparatus. When a record of music data of, for example, one piece of music is completed, the completion information transmitting means transmits the record completion information representative of a record completion, to the control apparatus. The title information receiving means receives title information (e.g., a disk title, track titles and the like) corresponding to the record completion information transmitted from the completion information transmitting means, from the control apparatus. The registering means registers the title information received by the title information receiving means in a record medium (e.g., MD) recorded with the music data. The identification information receiving means of the control apparatus receives the identification information transmitted from the recording/reproducing apparatus by the identification information transmitting means. The communication means communicates with a desired management server for managing disk information of reproduction media via a network, and receives the subject disk information from the management server by using the identification information received by the identification information receiving means. The completion information receiving means receives the record completion information transmitted from the recording/reproducing apparatus by the completion information transmitting means. When the completion information receiving means receives the record completion information, the title information transmitting means transmits the title information corresponding to the record completion information among the disk information received by the communication means, to the recording/reproducing apparatus. As described above, the control apparatus transmits the title information corresponding to the music data recorded completely to the recording/reproducing apparatus, by using the disk information acquired from the management server. The recording/reproducing apparatus registers the received title information in the record medium. It is therefore easy to register the title information in a medium capable of recording music data and the like.

The control apparatus may further comprise input means such as a keyboard and a mouse for inputting the title information and the title information transmitting means may transmit title information input from the input means to the recording/reproducing means, if the communication means cannot receive the disk information. In this case, since the title information input from the control apparatus which is relatively easy to input information, is registered in a record medium, it is easy to register the title information in the medium capable of recording music data and the like.

In order to achieve the above object, according to a second aspect of the invention, there is provided an audio system having a recording/reproducing apparatus for reproducing/recording music data and a control apparatus for controlling the recording/reproducing apparatus, respectively connected via a predetermined interface, wherein:

the recording/reproducing apparatus transmits identification information for identifying a reproduction medium recorded with music data, to the control apparatus, receives corresponding title information when a record of the music data is completed, from the control apparatus, and registers the received title information in a record medium recorded with the music data; and

when the control apparatus receives the identification information transmitted from the recording/reproducing apparatus, the control apparatus communicates with a desired management server for managing disk information of reproduction media via a network, and receives subject disk information from the management server by using the received identification information, and when a record by the recording/reproducing apparatus is completed, the control apparatus transmits the title information among the received disk information to the recording/reproducing apparatus.

According to the invention, the recording/reproducing apparatus transmits the identification information (e.g., TOC information) for identifying a reproduction medium (e.g., CD) recorded with music data, to the control apparatus, receives corresponding title information (e.g., a disk title, and track titles) when a record of the music data is completed, from the control apparatus, and registers the received title information in a record medium (e.g., MD) recorded with the music data. When the control apparatus receives the identification information transmitted from the recording/reproducing apparatus, the control apparatus communicates with a desired management server for managing disk information of reproduction media via a network, and receives subject disk information from the management server by using the received identification information, and when a record by the recording/reproducing apparatus is completed, the control apparatus transmits the title information among the received disk information to the recording/reproducing apparatus. It is therefore easy to register the title information in a medium capable of recording music data and the like.

In order to achieve the above object, according to a second aspect of the invention, there is provided a control apparatus for controlling via a predetermined interface a recording/reproducing apparatus for reproducing a reproduction medium recorded with music data and recording the reproduced music data in a record medium, comprising:

identification information receiving means for receiving identification information for identifying the reproduction medium from the recording/reproducing apparatus;

communication means for communicating with a desired management server for managing disk information of reproduction media via a network and for receiving subject disk information from the management server by using the identification information received by the identification information receiving means;

completion information receiving means for receiving record completion information representative of a record completion transmitted from the recording/reproducing means when a record of the music data is completed; and

title information registering means for transmitting title information corresponding to the record completion information among the disk information received by the communication means, to the recording/reproducing apparatus, when the completion information receiving means receives the record completion information, and for registering the title information in the record medium.

According to the invention, the identification information receiving means receives identification information (e.g., TOC information) for identifying the reproduction medium (e.g., CD) from the recording/reproducing apparatus. The communication means communicates with a desired management server for managing disk information of reproduction media via a network and receives subject disk information from the management server by using the identification information received by the identification information receiving means. The completion information receiving means receives record completion information representative of a record completion transmitted from the recording/reproducing means when a record of the music data of, for example, one piece of music is completed. The title information registering means transmits title information (e.g., a disk title and track titles) corresponding to the record completion information among the disk information received by the communication means, to the recording/reproducing apparatus, when the completion information receiving means receives the record completion information, and registers the title information in a record medium (e.g., MD). It is therefore easy to register the title information in a medium capable of recording music data and the like.

In order to achieve the above object, according to a second aspect of the invention, there is provided a title information registering method for an audio system having a recording/reproducing apparatus for reproducing/recording music data and a control apparatus for controlling the recording/reproducing apparatus, respectively connected via a predetermined interface, comprising steps of:

identification information receiving step of receiving identification information for identifying a reproduction medium recorded with music data, from the recording/reproducing apparatus;

communication step of communicating with a desired management server for managing disk information of reproduction media via a network and receiving subject disk information from the management server by using the identification information received by the identification information receiving step;

completion information receiving step of receiving record completion information representative of a record completion, from the recording/reproducing apparatus, when a record of the music data is completed by the recording/reproducing apparatus; and

title information registering step of transmitting title information corresponding to the record completion information among the disk information received at the communication step, to the recording/reproducing apparatus, when the completion information receiving step receives the record completion information, and registering the title information in the record medium recorded with the music data.

According to the invention, the identification information receiving step receives identification information (e.g., TOC information) for identifying a reproduction medium (e.g., CD) recorded with music data, from the recording/reproducing apparatus. The communication step communicates with a desired management server for managing disk information of reproduction media via a network and receives subject disk information from the management server by using the identification information received by the identification information receiving step. The completion information receiving step receives record completion information representative of a record completion, from the recording/reproducing apparatus, when a record of the music data is completed by the recording/reproducing apparatus. The title information registering step transmits title information (e.g., a disk tile and track titles) corresponding to the record completion information among the disk information received at the communication step, to the recording/reproducing apparatus, when the completion information receiving step receives the record completion information, and registers the title information in the record medium (e.g., MD) recorded with the music data. It is therefore easy to register the title information in a medium capable of recording music data and the like.

### BRIEF DESCRIPTION OF THE DRAWINGS

FIG. 1 is a block diagram showing an example of the structure of an audio system according to an embodiment of the invention.

FIG. 2 is a block diagram showing an example of the structure of a recording/reproducing apparatus.

FIG. 3 is a block diagram showing an example of the structure of a personal computer.

FIG. 4 is a flow chart illustrating a reproducing/recording process according to an embodiment of the invention.

FIG. 5 is a flow chart illustrating a title information registration process according to an embodiment of the invention.

FIG. 6 is a schematic diagram showing an example of an edit image generated by an image processing unit of a personal computer and displayed on an image display unit.

FIG. 7 is a flow chart illustrating a title information registration process to be executed by a conventional recording/reproducing apparatus.

### DETAILED DESCRIPTION OF THE PREFERRED EMBODIMENTS

An audio system according to an embodiment of the invention will be described with reference to the accompanying drawings.

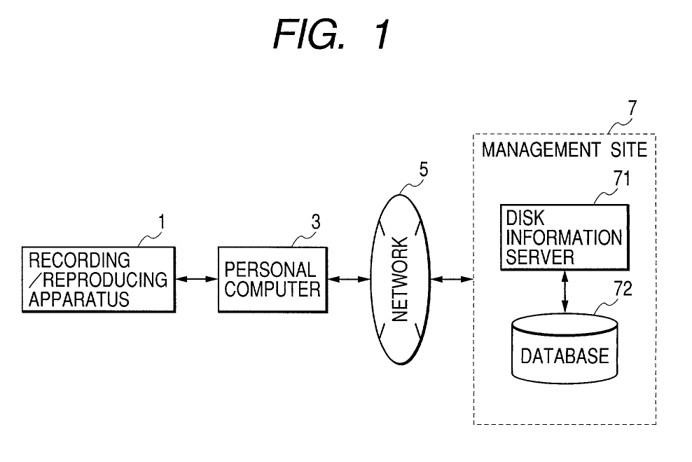

FIG. 1 is a block diagram showing an example of an audio system according to an embodiment of the invention. As shown in FIG. 1, the audio system has a recording/reproducing apparatus 1, a personal computer 3 and a management site 7, the personal computer 3 and management site 7 being connected via a network 5 such as the Internet. The recording/reproducing apparatus 1 and personal computer 3 are connected via a predetermined signal cable.

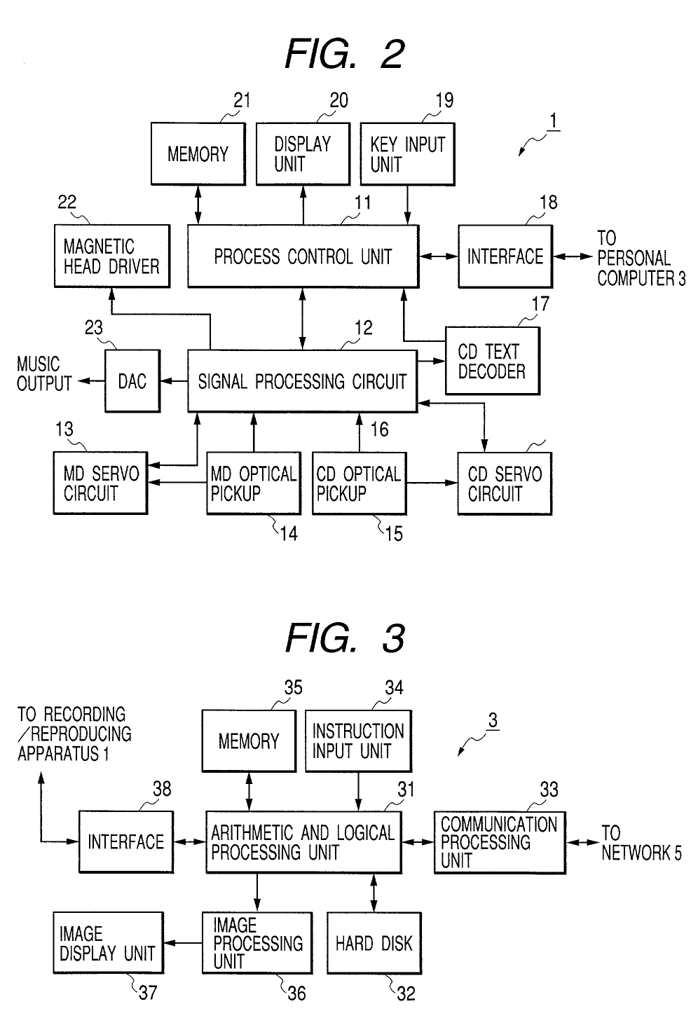

The recording/reproducing apparatus 1 will be described. The recording/reproducing apparatus 1 reproduces a CD (compact disk) and records the reproduced music data in an MD (mini disk), and is connected via a predetermined cable. The recording/reproducing apparatus 1 will be described in detail with reference to FIG. 2.

FIG. 2 is a block diagram showing an example of the structure of the recording/reproducing apparatus 1. As shown, the recording/reproducing apparatus 1 has a process control unit 11, a signal processing circuit 12, an MD servo circuit 13, an MD optical pickup 14, a CD optical pickup 15, a CD servo circuit 16, a CD text decoder 17, an interface 18, a key input unit 19, a display unit 20, a memory 21, a magnetic head driver 22 and a DAC 23.

The process control unit 11 is made of one-chip microcomputer having a CPU (Central Processing Unit) and a peripheral LSI (Large Scale Integration), and controls the entirety of the recording/reproducing apparatus 1.

More specifically, the process control unit 11 reproduces a CD by controlling the CD optical pickup 15, CD servo circuit 16 and the like, and records the obtained music data in an MD via the magnetic head driver 22 and the like.

The process control unit 11 reads TOC information from CD and sends the read TOC information to the personal computer 3 via the interface 18 and the like. This TOC information includes the total number of tracks and the total performance time (minute : second : frame) and the like, and is used for the personal computer 3 (management site 7) to identify CD. If the CD to be reproduced is a CD text disk, the process control unit 11 acquires text data recorded in the CD text disk via the CD text decoder 17 and transmits the acquired text data to the personal computer 3.

The process control unit 11 receives the title information including a disk title, track titles and the like sent from the personal computer 3, and registers the received title information in MD.

The signal processing circuit 12 controls the MD servo circuit 13, MD optical pickup 14, CD optical pickup 15, CD servo circuit 16, magnetic head driver 22 and the like. For example, the signal processing circuit 12 reproduces CD and reads music data by controlling the CD optical pickup 15 and the like, and record the music data in MD by controlling the magnetic head driver 22 and the like.

The MD servo circuit 13 drives and controls an unrepresented spindle motor for rotating a predetermined turntable on which MD as a recording medium is placed, to thereby rotate the turntable at a predetermined revolution speed.

The MD servo circuit 13 drives and controls an unrepresented thread motor for moving in parallel the MD optical pickup 14 along the MD radial direction, to thereby move the MD optical pickup 14 to a predetermined position of the recording surface of MD.

The MD optical pickup 14 applies a laser beam to the recording surface of MD to heat the recording surface to a Curie point or higher, during music data record.

During music data reproduction, the MD optical pickup 14 applies a laser beam having a predetermined wavelength to the recording surface of MD, and receives a reflected laser beam to convert it into an electric signal. The MD optical pickup 14 supplies the converted electric signal to the signal processing circuit 12 as music data and the like.

The CD optical pickup 15 applies a laser beam having a predetermined wavelength to the recording surface of CD, and receives a reflected laser beam to convert it into an electric signal. The CD optical pickup 15 supplies the converted electric signal to the signal processing circuit 12 as music data and the like.

The CD servo circuit 16 drives and controls an unrepresented spindle motor for rotating a turntable on which CD as a reproduction medium is placed, to thereby rotate the turntable at a predetermined revolution speed. The CD servo circuit 16 drives and controls a thread motor for moving in parallel the CD optical pickup 15 along the MD radial direction, to thereby move the CD optical pickup 15 to a predetermined position of the recording surface of CD.

The CD text decoder 17 decodes text data recorded in a CD text disk in conformity with the CD text specification, and supplies the decoded text data to the process control unit 11.

The interface 18 is, for example, a USB (Universal Serial Bus) or the like, and transfers predetermined data to and from the personal computer 3 connected by the predetermined cable.

The key input unit 19 is made of predetermined button switches, rotary switches and the like, inputs instruction information and the like corresponding to the key input by a user, and supplies the input information to the process control unit 11. For example, the key input unit 19 supplies the process control unit 11 with information of instructing to record (reproduction/record) music data from CD to MD when a particular key is depressed by a user.

The display unit 20 is made of an LCD (Liquid Crystal Display) panel or the like, and controlled by the process control unit 11 to display character strings and the like in order to notify the user of the operation status and the like. For example, the display unit 20 displays a track number of music data during recording, a remaining time until the recording is completed, and the like.

The memory 21 is a RAM (Random Access Memory) or the like and has a reserved write area for registering title information in MD. In this write area of the memory 21, the title information acquired from the personal computer 3 via the interface 18 is temporarily stored.

The magnetic head driver 22 controls an unrepresented magnetic head. Namely, during the recording operation, the magnetic head driver 22 controls the magnetic head to make the MD optical pickup 14 magnetize a predetermined area of the recording surface of MD heated to the Curie point or higher, to thereby record music data and title information in MD.

DAC (digital/analog converter) 23 converts digital tone signals supplied from the signal processing circuit 12 into analog tone signals, and outputs the converted tone signals as voices (music sounds) via a predetermined amplifier, speaker and the like.

Reverting to FIG. 1, the personal computer 3 will be described. The personal computer 3 controls the recording/reproducing apparatus 1 connected via the predetermined cable, and communicates with the management site 7 via the network 5 to acquire disk information of CD from the management site 7. The personal computer 3 will be described in detail with reference to FIG. 3.

FIG. 3 is a block diagram showing an example of the structure of the personal computer 3. As shown, the personal computer 3 has an arithmetic and logical processing unit 31, a hard disk 32, a communication processing unit 33, an instruction input unit 34, a memory 35, an image processing unit 36, an image display unit 37 and an interface 38.

The arithmetic and logical processing unit 31 is made of a CPU (Central Processing Unit) and the like, and controls the entirety of the personal computer 3. More specifically, the arithmetic and logical processing unit 31 controls the communication processing unit 33 to communicate with the management site 7 via the network 5. Disk information is acquired from the management site 7, and the disk title, track titles and the like (title information) contained in the acquired disk information are stored in the memory 35 and the like.

The arithmetic and logical processing unit 31 makes the image display unit 37 display a predetermined edit image, acquires the disk title, track titles and the like input from the instruction input unit 34 by a user, and stores the title information in the memory 35 and the like as changed (or input) title information.

The arithmetic and logical processing unit 31 supplies the recording/reproducing apparatus 1 with the title information stored in the memory 35 and the like, in accordance with the instruction information input from the instruction input unit 34.

The hard disk 32 is a magnetic disk or the like having a predetermined capacity, and stores programs for the title information registration process to be described later, and other data. The hard disk 32 may store disk information acquired from the management site 7 via the communication processing unit 33, as a pair of TOC information acquired from the recording/reproducing apparatus 1.

The communication processing unit 33 is made of a modem, a TA (Terminal Adapter) and the like, controlled by the arithmetic and logical processing unit 31, and communicates with the management site 7 via the network 5 to transfer predetermined data to and from the management site 7.

The instruction input unit 34 is made of a keyboard, mouse and the like, and supplies predetermined instruction information corresponding to the operation by a user to the arithmetic and logical processing unit 31. For example, in accordance with a keyboard operation by a user, the instruction input unit 34 inputs a disk title, track titles and the like (title information), and supplies the title information to the arithmetic and logical processing unit 31.

The memory 35 is a RAM or the like and has a reserved title area for edition or the like of the title information. The memory 35 temporarily stores in this title area, information (title information derived from disk information) acquired from the management site 7 via the communication processing unit 33, title information input via the instruction input unit 34 and the like.

The image processing unit 36 is made of a graphic controller and the like, and controlled by the arithmetic and logical processing unit 31 to generate predetermined image data to be displayed on the image display unit 37. For example, the image processing unit 36 generates an edit image for editing the title information.

The interface 38 is, for example, a USB interface or the like, and transfers predetermined data to and from the recording/reproducing apparatus 1 connected via the predetermined cable.

Revering to FIG. 1, the management site 7 is, for example, a Web site which manages disk information of a number of commercial available music CD's, the disk information including at least disk titles, track titles and the like. The management site 7 has a disk information server 71 and a database 72, and communicates with the personal computer 3 via the network 5.

The disk information server 71 is, for example, a general work station or the like having a communication control apparatus and the like, and transfers predetermined data to and from the personal computer 3 via the network 5.

The database 72 stores disk information of CD's (information including disk titles, track titles and the like) in correspondence with TOC information for identifying each CD.

In the following, the operation of the audio system according to the embodiment of the invention will be described with reference to the accompanying drawings.

The whole operation of the audio system will be described by describing the reproducing/recording process to be executed by the recording/reproducing apparatus 1 and the title registration process to be executed by the personal computer 3.

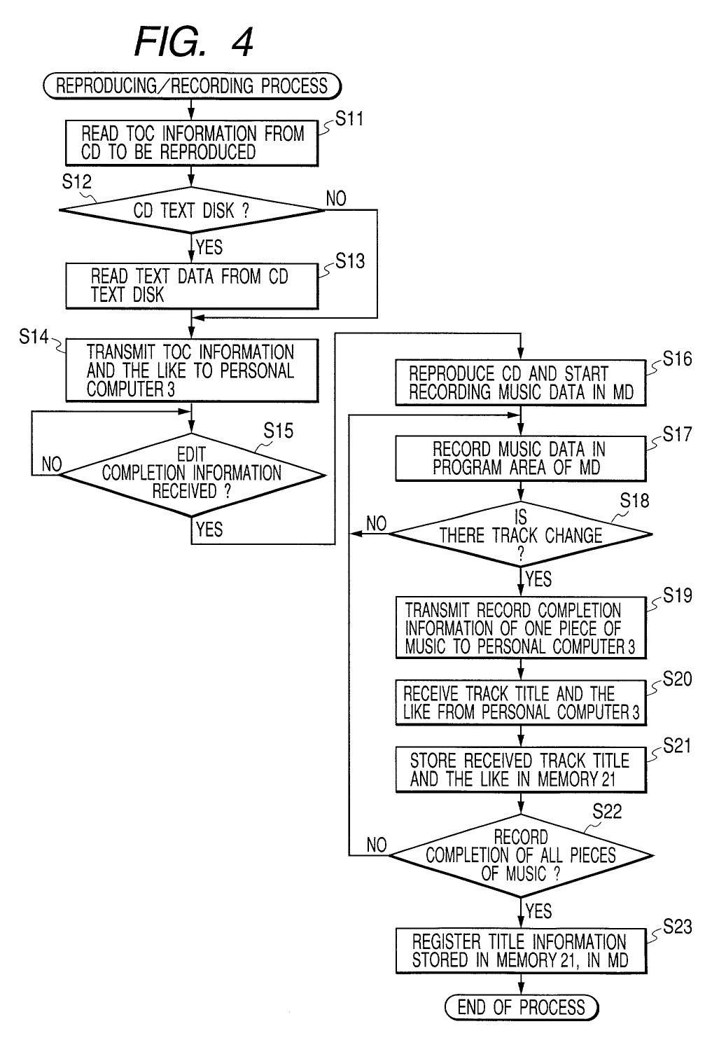

First, the reproducing/recording process will be described with reference to FIG. 4. FIG. 4 is a flow chart illustrating the reproducing/recording process to be executed by the process control unit 11 of the recording/reproducing apparatus 1. This reproducing/recording process starts, for example, when a user loads a CD to be reproduced and an MD capable of being recorded in the recording/reproducing apparatus, operates the key input unit 19, and inputs information of instructing reproduction/record.

First, the process control unit 11 controls the CD optical pickup 15 and the like to read TOC information from CD to be reproduced (Step S11).

The process control unit 11 judges from the read TOC information whether CD is a CD text disk (Step S12).

Only when the process control unit 11 judges that CD is a CD text disk, text data is read from CD (Step S13). Namely, the process control unit 11 acquires text data from CD via the CD text decoder 17.

The process control unit 11 transmits TOC information and the like to the personal computer 3 via the interface 18 (Step S14). While the text data is read at Step S13, the process control unit 11 transmits not only the TOC information but also the text data to the personal computer 3.

The process control unit 11 stands by until it receives edit completion information from the personal computer 3 (Step S15). Namely, the process stands by until the edit completion information sent from the personal computer 3 is received after the personal computer 3 for executing the title information registration process to be described later acquires the title information from the management site 7 or the like and necessary edit works are completed by the user.

Upon reception of the edit completion information, the process control unit 11 reproduces CD by controlling the CD optical pickup 15 and the like via the signal processing circuit 12, and starts recording the music data in MD by controlling MD optical pickup 14 and the like (Step S16).

Then, the process control unit 11 records the music data in the program area of MD by controlling the magnetic head driver 22 and the like (Step S17).

The process control unit 11 judges whether there is a track change (Step S18). Namely, the process control unit 11 judges whether the music data of one piece of music has been completely recorded.

The process control unit 11 continues to record the music data at Step S17 until there is a track change. When it is judged that there is a track change, the process control unit 11 generates record completion information representative of a record completion of the music data of one piece of music, and transmits the generated record completion information to the personal computer 3 via the interface 18 (Step S19).

The process control unit 11 receives the track title and the like transmitted in response to the record completion information, from the personal computer 3 via the interface 18 (Step S20). When the record completion information for the first music data is transmitted at Step S19 (when the record of the first piece of music is completed), the process control unit 11 receives the disk title and track title sent from the personal computer 3.

The process control unit 11 stores the received track title and the like (title information) in the write area of the memory 21 (Step S21).

The process control unit 11 judges whether all the music data has been recorded completely (Step S22).

If the process control unit 11 judges that all the music data is not recorded completely, the flow returns to Step S17 to repeat the process at Steps S17 to S22. If it is judged that all pieces of music have been recorded completely, the process control unit 11 registers the title information (disk title, track titles and the like) stored in the write area of the memory 21, in MD (Step S23).

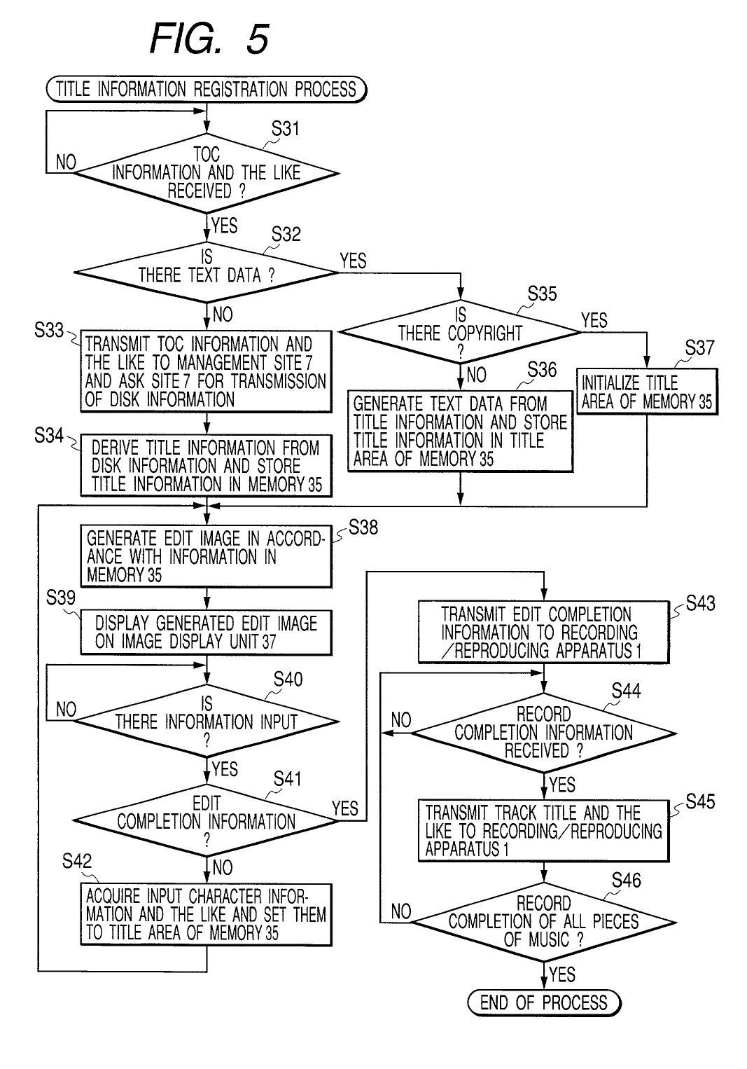

Next, the title information registration process will be described with reference to FIG. 5. FIG. 5 is a flow chart illustrating the title information registration process to be executed by the arithmetic and logical processing unit 31 of the personal computer 3. This title information registration process is executed in parallel to the above-described reproducing/recording process.

First, the arithmetic and logical processing unit 31 stands by until TOC information and the like are received from the recording/reproducing apparatus 1 (Step S31).

Upon reception of the TOC information and the like, the arithmetic and logical processing unit 31 judges whether the received information contains text data (Step S32). Namely, it is judged in the above-described reproducing/recording process whether the CD to be reproduced is a CD text disk and whether TOC information and text data are transmitted from the recording/reproducing apparatus 1.

If the arithmetic and logical processing unit 31 judges that text data is not transmitted, it transmits the TOC information to the management site 7 to ask this site 7 for the transmission of disk information (Step S33). Namely, the arithmetic and logical processing unit 31 transmits the TOC information acquired from the recording/reproducing apparatus 1 to the management site 7 via the communication processing unit 33 and the like, and requests the management site 7 to transmit the disk information.

Upon reception of the transmission request from the personal computer 3, the disk information server 71 of the management site 7 acquires the TOC information transmitted together with the transmission request.

The disk information server 71 acquires the subject disk information from the database 72, by using the acquired TOC information as a search key, and transmits the acquired disk information to the personal computer 3.

Upon reception of the disk information transmitted from the management site 7 via the communication processing unit 33, the arithmetic and logical processing unit 31 derives the title information (disk title, track titles and the like) from the received disk information, and stores then in the title area of the memory 35 (Step S34). If the title information is not managed by the management site 7, the arithmetic and logical processing unit 31 receives the information to this effect, and initializes the title area of the memory 35.

If it is judged at Step S32 that the text data is transmitted, the arithmetic and logical processing unit 31 judges whether the received text data contains information of claiming a copyright (Step S35).

If the arithmetic and logical processing unit 31 judges that there is no information of claiming a copyright, it generates title information from the text data, and stores the generated title information in the title area of the memory 35 (Step S36).

If it is judged that there is information of claiming a copyright, the arithmetic and logical processing unit 31 initializes the title area of the memory 35 (Step S37).

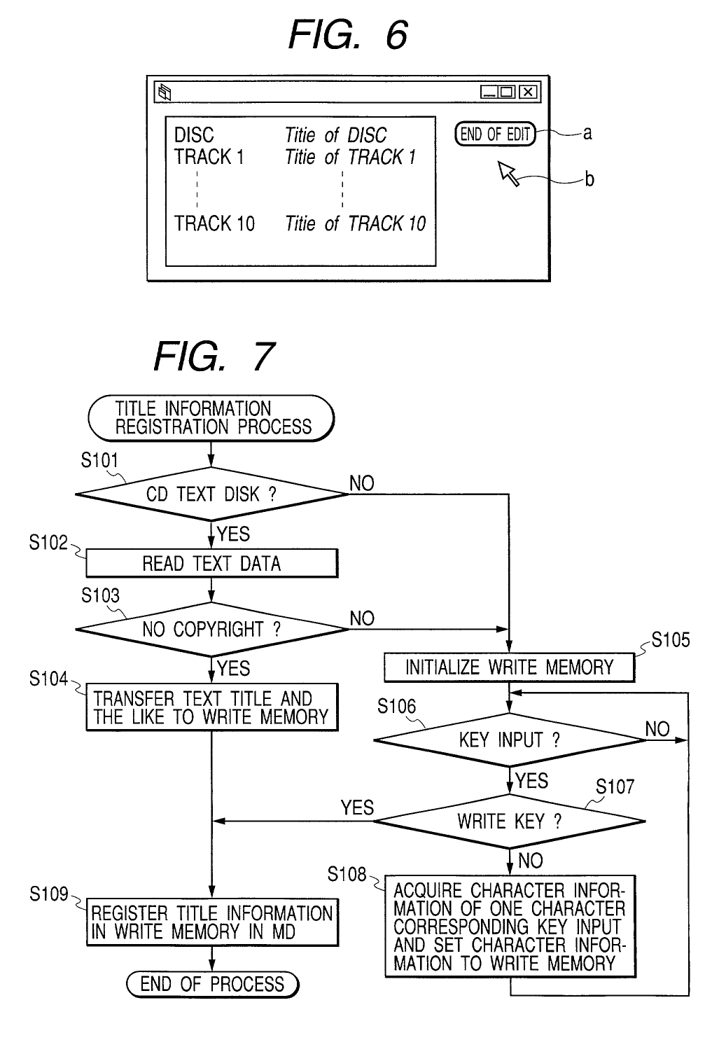

When the title information is set to the title area of the memory 35 by the process at Steps S34, S36 and S37, the arithmetic and logical processing unit 31 controls the image processing unit 36 to generate an edit image in accordance with the set information (Step S38). For example, if the title information acquired from the management site 7 or the like is stored in the title area of the memory 35, the image processing unit 36 generates an edit image such as shown in FIG. 6.

The arithmetic and logical processing unit 31 (image processing unit 36) displays the generated edit image on the image display unit 37 (Step S39).

The arithmetic and logical processing unit 31 stands by until predetermined information is input from the instruction input unit 34 (Step S40).

When information is input from the instruction input unit 34, the arithmetic and logical processing unit 31 judges whether the input information is edit completion information (Step S41). For example, the edit completion information is input when a user clicks an edit completion button a shown in FIG. 6 with a mouse cursor b.

If it is judged that the input information is not edit completion information, the arithmetic and logical processing unit 31 acquires input character information and the like, and sets them to the title area of the memory 35 as the title information (Step S42). Namely, the arithmetic and logical processing unit 31 acquires the input disk title, track titles and the like, and stores them in the memory 35 and the like as the changed (or input) title information.

Thereafter, the flow returns to Step S38 and the arithmetic and logical processing unit 31 repetitively executes the process at Steps S38 to 42. Namely, the arithmetic and logical processing unit 31 repeats a process of receiving character information and the like, updating the title information in the title area, and generating and displaying the edit image reflecting the updated contents.

If it is judged at Step S41 that the edit completion information is input, the arithmetic and logical processing unit 31 generates edit completion information representative of an edit completion of the title information, and transmits the edit completion information to the recording/reproducing apparatus 1 via the interface 38 (Step S43). As described earlier, during the reproducing/recording process, upon reception of this edit completion information, the recording/reproducing apparatus 1 starts recording music data from CD to MD.

The arithmetic and logical processing unit 31 stands by until record completion information of one piece of music is received which is transmitted from the recording/reproducing apparatus 1 started the record operation via the interface 38 (Step S44).

Upon reception of the record completion information, the arithmetic and logical processing unit 31 acquires the corresponding track title and the like from the title area of the memory 35, and transmits the acquired track title and the like to the recording/reproducing apparatus 1 (Step S45). When the record completion information for the music data of a first piece of music is received (when the record of a first piece of music is completed at the recording/reproducing apparatus 1), the arithmetic and logical processing unit 31 transmits the disk title and track title to the recording/reproducing apparatus 1.

The arithmetic and logical processing unit 31 judges whether the recording/reproducing apparatus 1 has completely recorded all music data (Step S46). If the arithmetic and logical processing unit 31 judges that all pieces of music are not recorded completely, the flow returns to Step S44 to repeat the process at Steps S44 to S46. If the arithmetic and logical processing unit 31 judges that all pieces of music are recorded completely, the arithmetic and logical processing unit 31 terminates the title information registration process.

As described above, the personal computer 3 transmits the title information corresponding to the recorded music data to the recording/reproducing apparatus 1, by using the disk information acquired from the management site 7. The recording/reproducing apparatus 1 registers the title information sent from the personal computer 3 in MD. It is therefore easy to register title information in a medium capable of recording music data and the like.

Even if disk information cannot be acquired from the management site 7, a user can input title information from the personal computer 3 (instruction input unit 34) which is relatively easy to input information. The title information corresponding to the recorded music data is sent to the recording/reproducing apparatus 1 and registered in MD. Also in this case, it is easy to register title information in a medium capable of recording music data and the like.

In either of the above cases, an edit image is displayed on the image display unit 37 of the personal computer 3 so that a user can easily edit title information.

In the above-described embodiment, although TOC information for identifying CD or the like to be reproduced is used, ISRC (International Standard Recording Code) information in Q codes and the like may also be used.

In the above embodiment, a recording/reproducing apparatus for recording music data in MD has been described. The medium to be recorded is not limited only to MD, but other recording/reproducing apparatuses may also be used which record music data in an MO (Magneto-Optical) disk or a DVD-RAM (Digital Versatile Disk RAM) disk. Further, other recording/reproducing apparatuses may also be used which record music data in an Smart Media (trademark) and a Memory Stick (trademark).

What is claimed is:

1. An audio system having a recording/reproducing apparatus and a control apparatus for controlling to said recording/reproducing apparatus, said control apparatus being connected to an external network, said system comprising:
means contained in said recording/reproducing apparatus for transmitting to said control apparatus identification information for identifying a reproduction medium;
means contained in said control apparatus for communicating with said external network to acquire subject disc information from said external network on the basis of said identification information;
means contained in said control apparatus for extracting title information from said acquired subject disc information and for transmitting said extracted title information to said recording/reproducing apparatus in response to the completion of a record in said recording/reproducing apparatus; and
means contained in said recording/reproducing apparatus for registering in a record medium said title information.

2. An audio system having a recording/reproducing apparatus for reproducing/recording music data and a control apparatus for controlling the recording/reproducing apparatus, said control apparatus being connected via a predetermined interface to said recording/reproducing apparatus,
CHARACTERIZED IN THAT
said recording/reproducing apparatus comprises:
identification information transmitting means for transmitting identification information for identifying a reproduction medium recorded with music data, to the control apparatus;
completion information transmitting means for transmitting record completion information representative of a record completion, to the control apparatus, when a record of the music data is completed;
title information receiving means for receiving title information corresponding to the record completion information transmitted from said completion information transmitting means, from the control apparatus; and
registering means for registering in a record medium recorded with the music data the title information received by said title information receiving means, and
said control apparatus comprises:
identification information receiving means for receiving the identification information transmitted from the recording/reproducing apparatus by said identification information transmitting means;
communication means for communicating with a desired management server for managing disk information of reproduction media via a network and for receiving subject disk information from the management server by using the identification information received by said identification information receiving means;
completion information receiving means for receiving the record completion information transmitted from the recording/reproducing means by said completion information transmitting means; and
title information transmitting means for transmitted the title information corresponding to the record completion information among the disk information received by said communication means, to the recording/reproducing apparatus, when said completion information receiving means receives the record completion information.

3. The audio system according to claim 2, wherein the control apparatus further comprises input means for inputting the title information and said title information transmitting means transmits title information input from said input means to the recording/reproducing means, if said communication means cannot receive the disk information.

4. An audio system having a recording/reproducing apparatus for reproducing/recording music data and a control apparatus for controlling the recording/reproducing apparatus, said control apparatus being connected via a predetermined interface to said recording/reproducing apparatus,
CHARACTERIZED IN THAT
the recording/reproducing apparatus transmits identification information for identifying a reproduction medium recorded with music data, to the control apparatus, receives corresponding title information when a record of the music data is completed, from the control apparatus, and registers the received title information in a record medium recorded with the music data; and
when the control apparatus receives the identification information transmitted from the recording/reproducing apparatus, the control apparatus communicates with a desired management server for managing disk information of reproduction media via a network, and receives subject disk information from the management server by using the received identification information, and when a record by the recording/reproducing apparatus is completed, the control apparatus transmits the title information among the received disk information to the recording/reproducing apparatus.

5. A control apparatus for controlling via a predetermined interface a recording/reproducing apparatus for reproducing a reproduction medium recorded with music data and recording the reproduced music data in a record medium, said apparatus comprising:
identification information receiving means for receiving identification information for identifying the reproduction medium from the recording/reproducing apparatus;
communication means for communicating with a desired management server for managing disk information of reproduction media via a network and for receiving subject disk information from the management server by using the identification information received by said identification information receiving means;
completion information receiving means for receiving record completion information representative of a record completion transmitted from the recording/reproducing means when a record of the music data is completed; and
title information registering means for transmitting title information corresponding to the record completion information among the disk information received by said communication means, to the recording/reproducing apparatus, when said completion information receiving means receives the record completion information, and for registering the title information in the record medium.

6. A title information registering method for use in an audio system having a recording/reproducing apparatus for reproducing/recording music data and a control apparatus for controlling the recording/reproducing apparatus, said control apparatus being connected via a predetermined interface to said recording/reproduction apparatus, said method comprising steps of:
identification information receiving step of receiving identification information for identifying a reproduction medium recorded with music data, from the recording/reproducing apparatus;
communication step of communicating with a desired management server for managing disk information of reproduction media via a network and receiving subject disk information from the management server by using the identification information received by said identification information receiving step;
completion information receiving step of receiving record completion information representative of a record completion, from the recording/reproducing apparatus, when a record of the music data is completed by the recording/reproducing apparatus; and
title information registering step of transmitting title information corresponding to the record completion information among the disk information received at said communication step, to the recording/reproducing apparatus, when said completion information receiving step receives the record completion information, and registering the title information in the record medium recorded with the music data.
